(19) United States
(12) Patent Application Publication
(10) Pub. No.: US 2014/0246436 A1
(43) Pub. Date: Sep. 4, 2014

(54) POLYMORPHIC CONTAINER FOR DISPOSAL OF PATHOGENS, BIOLOGICAL, BIO HAZARDOUS, ANAPATOLOGICAL AND HOSPITAL MATERIALS WITH HERMETIC CLOSURE

(71) Applicant: Pablo Poch Figueroa, Bogota (CO)

(72) Inventor: Pablo Poch Figueroa, Bogota (CO)

(21) Appl. No.: 14/111,944

(22) PCT Filed: Apr. 2, 2012
(86) PCT No.: PCT/IB12/00669

§ 371 Date: Oct. 15, 2013

(30) Foreign Application Priority Data
Apr. 13, 2011 (CO) 11- 045750

(51) Int. Cl. B65F 1/16

(52) U.S. Cl. CPC B65F 1/16
USPC 220/315

(57) ABSTRACT

This invention refers to a container with a lid which has a hermetic sealing and a non-perferating system for the deposit and transfer of polluting wastes from hospitals, laboratories, mortuaries, veterinary clinics, drug manufacturing plants, funeral homes, tattoo parlors, beauty salons and hairdressers to the final site where the hazardous materials will be treated. The system is characterized by not allowing its lid to be removed once the waste is deposited and closed, and does not allow the escape of liquid substances if the container is turned. Having hermetic coupling means (3), (6), (7), (8) and (9) and closing means (4), (5), (11) and (13),making it safe and inviolable,such that to reopen it can only be to destroy it, making it easy to move with maximum safety to reach the final destination where the waste will be treated. This container can be easily sterilized to avoid contaminating the hospital areas. This invention refers to a container made of polymorphic organic materials with a sealing cap with safety device that makes it so that once the waste is deposited and the cap closed, the lid cannot be removed.

### DESCRIPTION OF THE TECHNICAL STATE OF THE INVENTION

There are various containers known for being used in the deposit of hospital and laboratory waste, ranging from the red bag which gives no assurance as it is sensitive to punctures and tears; other types include stainless Steel pails and plastic bags that do not have a secure protocol for the handling of the waste. Containers for needles and scalpels can also be found that are neither tight nor do they give any security, leaving them vulnerable to accidents and breakages as well as danger from handeling by unscrupulous people that open them to reuse the contaminated items before, during and after being transported to the site where they will be professionally treated or incinerated. These are some of the patents on the technique that do not solve the problem ES 2033006(T3) AND MXPA02010053 (A)

The technical statement has made suggestions over the changes that must be made with these systems so as not permit that the materials may be subject to manipulation before reaching their final treatment destination.

### OBJECTIVE OF THE INVENTION

The main objective of this invention is to safeguard the health of society preventing that discarded items that have been infected with pathogenic, biological, and pathological substances to be placed again on the market or thrown anywhere exposing the population to infections by unscrupulous people that easily evade using conventional containers.

Another objective of this invention is to facilitate sterilization before use to avoid contaminating hospital areas and once closed, allow for sterilization before being incinerated thus avoiding contamination.

Another objective of this invention is to not allow any leakage of solid or liquid waste out of the container as it has different sealing systems.

Another objective is the construction of a container for waste that easily fit into one another when empty as well as for power supported one above the other being charged and capped. Additionally, this invention presents a new breakthrough in environmental protection, protecting the environment from substances hazardous to human health and because the container is made of environmentally friendly materials.

### DESCRIPTION OF THE INVENTION

Airtight Container for Pathogen Waste, is a rigid deposit to be used in clinics, hospitals, laboratories, mortuaries, veterinary clinics, drug stores, funeral homes, and hairdressers to collect medical, pollutants and infectious wastes their once the operation is performed it proceeds to close the container with its respective seal that for their respective closing does not allow the container to open again unless broken or destroyed. This container does not have right angles, it only has curved corners that prevent the accumulation of pollutant factors in the corners as would happen at a right angle; this ensures the safety in its handling at all stages of use since it is produced, stored, sterilized, used and transported to its final destination. It is also a Green container and easy to move, store and easy to operate; it is made of polyolefin additive das.

### BRIEF DESCRIPTION OF THE FIGURES

To further clarify the invention and its advantages compared with the known technique, below is the system is described with the help of the annexed drawings, with possible models used as examples of the application of these principles in the drawings.

In FIG. 1 we see a front view of the toxic waste container with the lid and its packaging.

FIG. 2 shows a top view of a part of the lid with its anchoring bar and slots.

In FIG. 3 we see a top view of the container slots where top toothed bars are anchored,

In FIG. 4 we see part of the container with a top view of the container cavity, the slots and its protector where the lid is locked and anchored.

FIG. 5 shows a front schematic cut of the anchoring and sealed system of the lid with the container.

FIG. 6 shows the anchoring system of the lid with the container through a cylindrical bar with contoured tapered slots.

In FIG. 7 we see how empty containers are stored before use.

In FIG. 8 we see how containers are stored for waste being loaded and sealed, ready to be disposed by the garbage collector entity to its final destination.

### DESCRIPTION OF THE INVENTION WITH RESPECT TO THE FIGURES

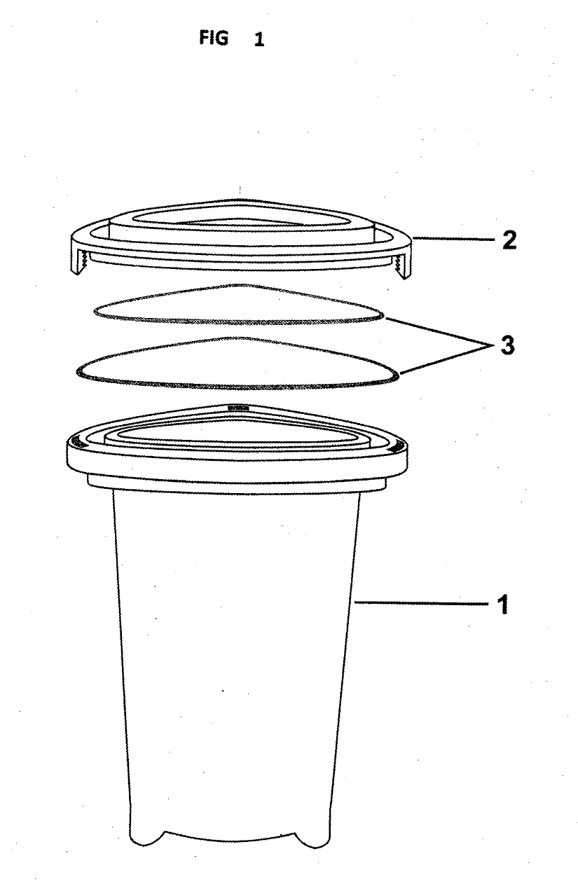

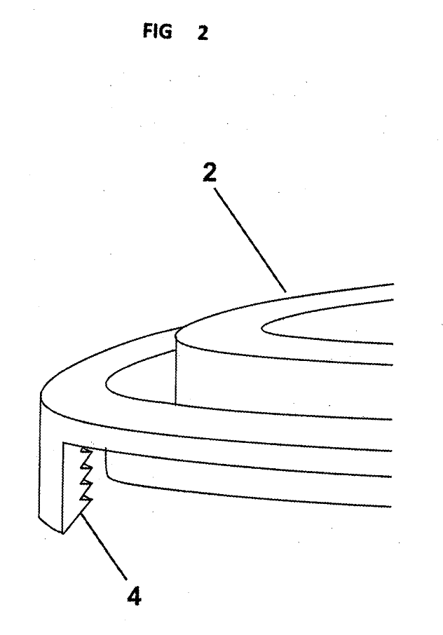

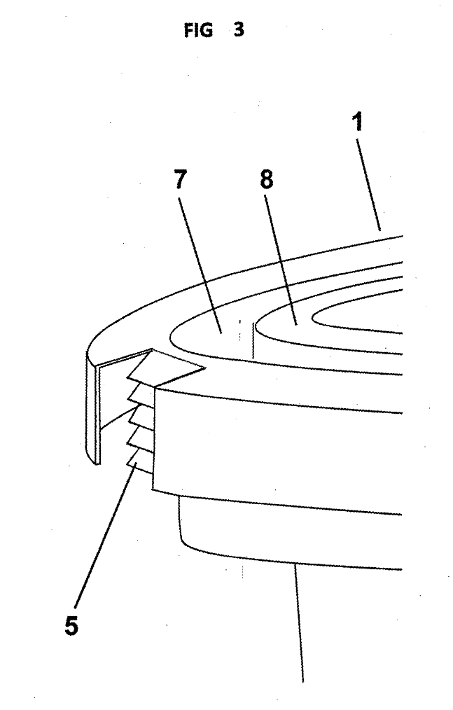

FIG. 1 shows a container for hospital waste 1 with its lid 2 and its two flexible packaging 3, FIG. 2 shows the anchoring system of the lid 2 which is a bar with slot 4 which anchors the lid to the container by means of its slots.

In FIG. 3 we see a container 1 with anchoring system with slots located opposite to 5 for coupling the toothed bars and anchoring the rods of the lid when the container is closed at 1 it also shows the cavity 7 and male vein 8.

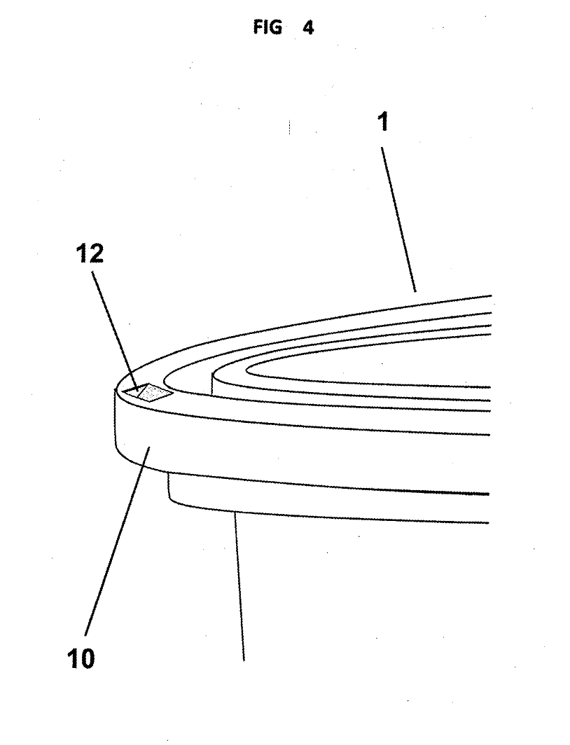

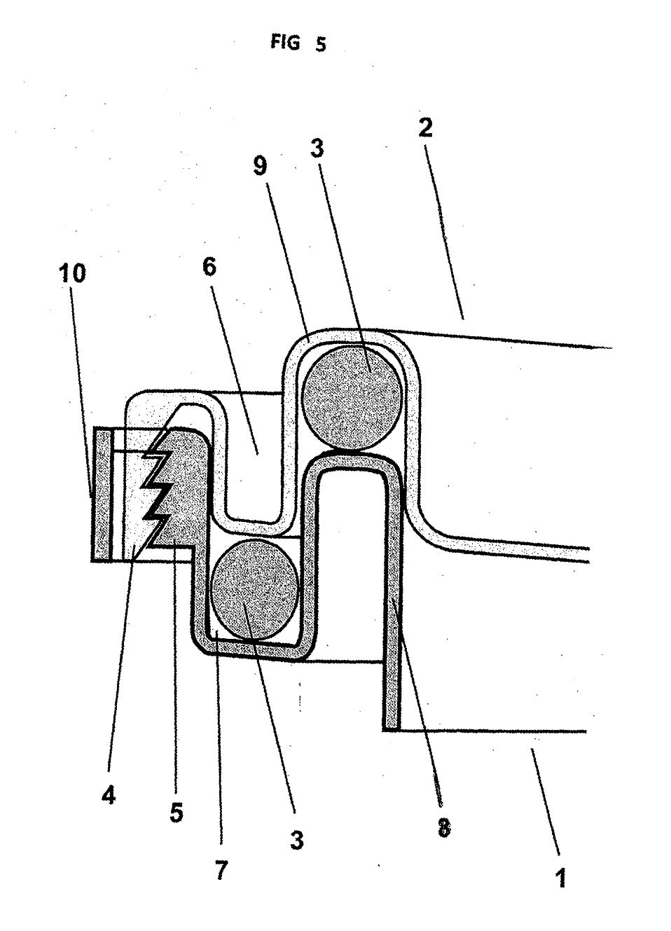

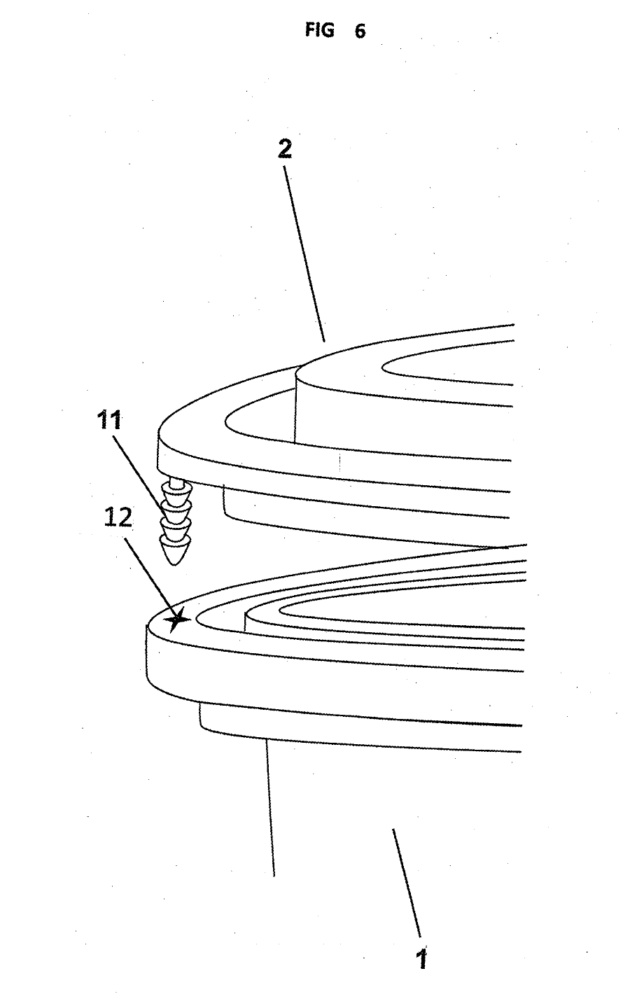

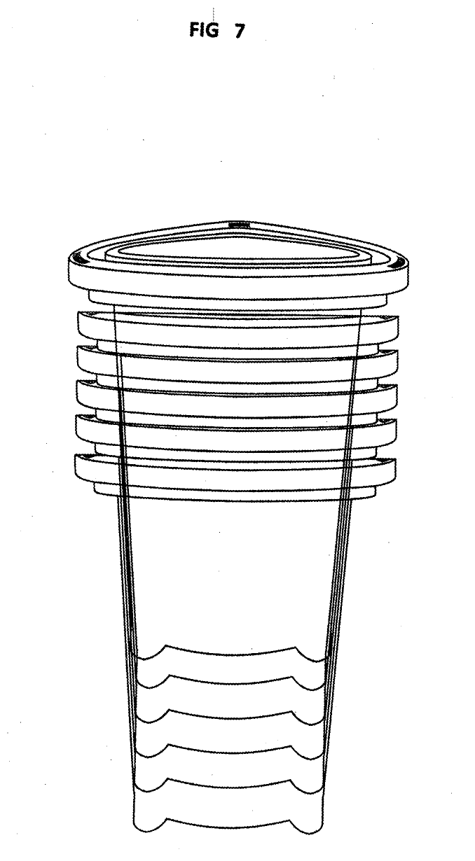

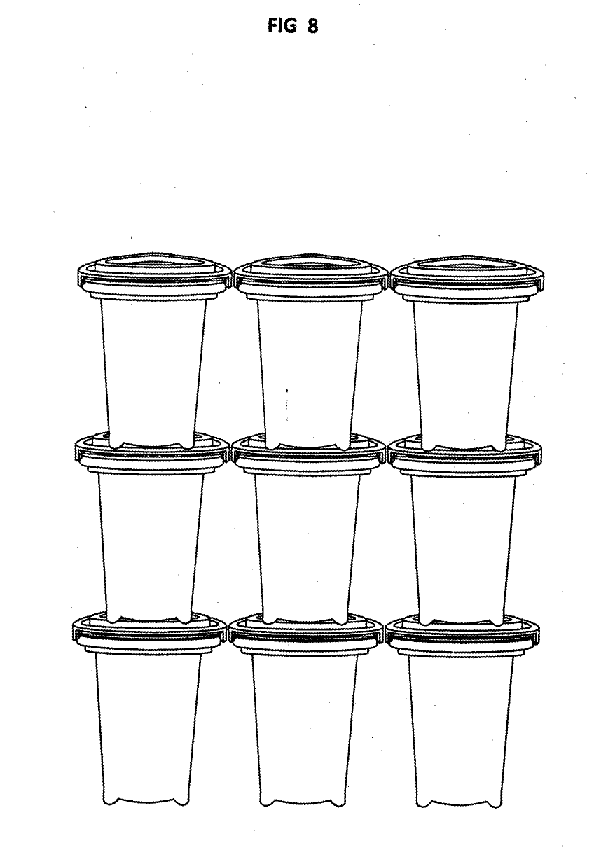

In FIG. 4 we see a container 1 with its edge protector 10 of sealing and anchoring hole 12 that guides and engages the anchoring system of slots of the lid and the container. In FIG. 5 we see a frontal cut of container 1 with its closed lid 2 and its peripheral package 3 flexible polymorphic located between the peripheral vein 6 of the lid 2 which makes seal with peripheral cavity 7 of the container 1 and we see the peripheral vein 8 of container 1 adjusting and making seal with other package 3 within the cavity 9 of lid 2 responsible for sealing the interior of the container 1 with lid 2, as in turn we see the toothed bar 4 of the lid 2 coupled, anchored and locked over the groves 5 located in container 1 which are, in charge of anchoring and blocking the opening of lid, 2 being these protected by the protective coating of edge 10 of the container. FIG. 6 shows the locking system of the lid 2 with container 1 a through a cylindrical rod with conical machined slots 11 which are inserted and anchored within the holes 12 of the edge of container 1 closing and blocking lid 2 and thus protected by the coating of edge 10 of container

FIG. 7 shows the storage of empty containers within each other. FIG. 8 shows how to store containers while they are closed.

### ITEMS LIST

1—Container for hospital waste

2—Container lid

3—Flexible packaging lid

4—Slotted safety bar

5—Safety slots located on the contrary in the container

6—Peripheral vein of the lid

7—Peripheral cavity of the edge of container

8—Peripheral male vein, male container

9—Lid cavity

10—Container protector edge

11—Cylindrical safety seal bar with conical-shaped machined grooves

12—Container edge orifices

1. The hermetic-sealing polymorphic container for Removal of Pathogenic, infectious and polluting materials, noted for its being a container with a lid and a hermetic-sealing mechanism of veins and cavities with packaging and anchoring meaning that it cannot be reopened, and having aseptic finishes made with ecological materials with many forms allowing for its storage.

2. Sealable container for disposal of Pathogenic, infectious and polluting materials, according to claim 1, characterized because it has in the lid (2) a grooved bar (4) which engages and locks into the grooves (5) position in the opposite direction on the container (1)

3. Sealable container for disposal of Pathogenic, infectious and polluting materials, according to claim 1, characterized because it has in the lid (2) a cylindrical rod with grooves cut in a conical shape (11) which are inserted and anchored and locked into holes (12) on the edge of the container (1)

4. Sealable container for disposal of pathogenic, infectious and polluting materials, according to claim 1, characterized because the lid (2) has an edge with male conical vein (6) which fits into the peripheral conical cavity (7) of the edge of the container (1)

5. Sealable container for disposal of pathogenic, infectious and polluting materials according to claim 1, characterized because the lid has on its edge a peripheral conical cavity (9) where fits the male conical vein (8) of the edge of the container (1)

6. Sealable container for disposal of pathogenic, infectious and polluting materials according to claim 1, characterized because it has a flexible polymorphic peripheral gasket (3) located between the veins (6) of the lid (2) and the cavity (7) of the container (1)

7. Sealable container for disposal of pathogenic, infectious and polluting materials according to claim 1 characterized because it has a flexible polymorphic peripheral gasket (3) between the cavity (9) of the lid (2) and the vein (8) of the container (1)

8. Sealable container for the disposal of pathogenic, infectious and polluting materials according to claim 1, characterized because the corners and angles within the container (1) and the lid (2) are curved.

9. Sealable container for the disposal of pathogenic, infectious and polluting materials according to claim 1, characterized because the container has a peripheral protector edge (11) which covers and protects the sealing systems (4), (59) and (11), (13) so they cannot be manipulated.

10. Sealable container for the disposal of pathogenic, infectious and polluting materials according to claim 1, characterized because by the conic shape of the container, it allows the storage into the other by being without lid.

11. Sealable container for disposal of pathogenic, infectious and polluting materials produced by hospitals and laboratories according to claim 1, characterized because the container and its lid are manufactured in poleolefin as aditiva das.
